(19) United States
(12) Patent Application Publication
(10) Pub. No.: US 2013/0277589 A1
(43) Pub. Date: Oct. 24, 2013

(54) SUBSEA VALVE SEAT ARRANGEMENTS

(71) Applicant: Simon Vaughan, Banchory (GB)

(72) Inventor: Simon Vaughan, Banchory (GB)

(73) Assignee: Aker Subsea Limited, Maidenhead (GB)

(21) Appl. No.: 13/883,639

(22) PCT Filed: Nov. 3, 2011
(86) PCT No.: PCT/GB11/01550

§ 371 Date: Jul. 8, 2013

(30) Foreign Application Priority Data
Nov. 5, 2010 (GB) 1018660.9

(51) Int. Cl. F16K 3/02

(52) U.S. Cl. CPC F16K 3/02
USPC 251/157

(57) ABSTRACT

A subsea valve comprises a valve gate (4) moveable within a valve cavity (3) and a main passageway (2) extends transversely of the cavity. At least one annular valve seat (6) is in communication with a respective portion of the main passageway and extends to engage the gate. An annular pocket (7, 7a) accommodates an end of the respective seat remote from the valve gate. The seat has at the said end an annular buffer (54) in radial engagement with the pocket (7) and comprising a multiplicity of cantilever springs (55) each extending radially and circumferentially of the rim of the seat.

### INTRODUCTION

This invention relates to subsea gate valves and particularly cutting valves. Such valves normally comprise a valve cavity in which a generally planar valve gate moves lengthwise, the gate having an aperture which in the open position of the valve is aligned with at least one valve seat in communication with a main fluid passageway. Normally there is a pair of annular valve seats each in communication with, and preferably aligned with, a respective portion of a main fluid passageway which extends transversely of the valve cavity. The or each valve seat is disposed in a respective valve pocket, preferably an annular recess extending around a respective portion of the main passageway extending from a side of the valve cavity.

The valve may be actuated by a hydraulic piston and cylinder assembly; but other forms of actuation such as electromagnetic, may be employed.

The gate is usually moveable in its plane between an open position and a closed position, in which the gate blocks passage between the valve seats and thereby passage through the main passageway. The movement between open and closed positions is preferably rapid. The valve gate may be subject to a restoring force (such as by means of a return spring) so that it will automatically close on de-activation of the actuator; but it may be disposed to fail in an open position or otherwise.

The action of the gate relative to the seats is a shearing action and the valve seats are thereby subject to considerable displacement forces both lateral (in the sense of movement of the gate) and axial. Moreover, the valve's parts, particularly the valve seats, are, having regard to the great possible variation in operating conditions, subject to thermal distortion. The fluid flow is also characterised by substantial vibration and debris.

A first aspect of the valve described herein is an improved means of supporting a valve seat and both valve seats where as usual there is a pair of such seats. Although it is generally desirable to make a valve seat as short and as wide as feasible and its pocket as deep as feasible, in practice the seat must have a substantial axial length unsupported by the respective valve pocket.

An important aspect of the valve described herein concerns the support of a valve seat in its pocket. It is desirable to achieve a close radial fit, so as to inhibit movement of the seat and to inhibit the ingress of debris, while also accommodating the thermal distortion which the seat and pocket experience in typical operating conditions.

### SUMMARY OF THE CLAIMED INVENTION

The invention provides a subsea valve comprising a valve gate moveable within a valve cavity; a main passageway extending transversely of the cavity; at least one annular valve seat in communication with a respective portion of the main passageway and extending to engage the gate, and an annular pocket accommodating an end of the respective seat remote from the valve gate; in which the seat has at the said end an annular buffer in radial engagement with the pocket and comprising a multiplicity of springs each extending radially and circumferentially of the seat.

The invention also provides a valve seat for use in a subsea gate valve and comprising an annular member having a first end for engagement with a valve gate and a second end for location in an annular pocket; in which the seat has at the said second end a rim carrying a multiplicity of springs each extending radially and circumferentially of the rim.

The springs may be in the form of flutes to provide a variable spring rate. In a preferred embodiment the tip of each flute overlaps the base of an adjacent flute in the circumferential direction.

The buffer may include a circumferential groove in the flutes and elastomeric filler in the groove to form a radial seal with the pocket.

To provide stability, elastomeric material may be interspersed between the springs.

### BRIEF DESCRIPTION OF THE DRAWINGS

FIG. 1 is a section view of a cutting valve.

FIG. 2 is a perspective view of a seat retaining clamp assembly.

FIG. 3 is a sectional view of part of the clamp assembly.

FIG. 4 is a sectional view of a detail of the clamp assembly.

FIG. 5 is a section view of a valve seat assembly.

FIG. 6 is a sectional view of the valve seat assembly in the region of a pocket for a valve seat.

FIG. 7 is a fragmentary view of part of the rim of a valve seat.

FIG. 8 is a side view of a valve seat.

FIG. 9 is a perspective view of a valve seat.

FIG. 10 is an end view of a valve seat.

FIG. 11 is a fragmentary sectional view of the rim of a valve seat.

FIG. 12 is a view corresponding to FIG. 6 but showing a modified valve seat.

FIG. 13 is a fragmentary view corresponding to FIG. 7 but showing the modified valve seat.

### DETAILED DESCRIPTION

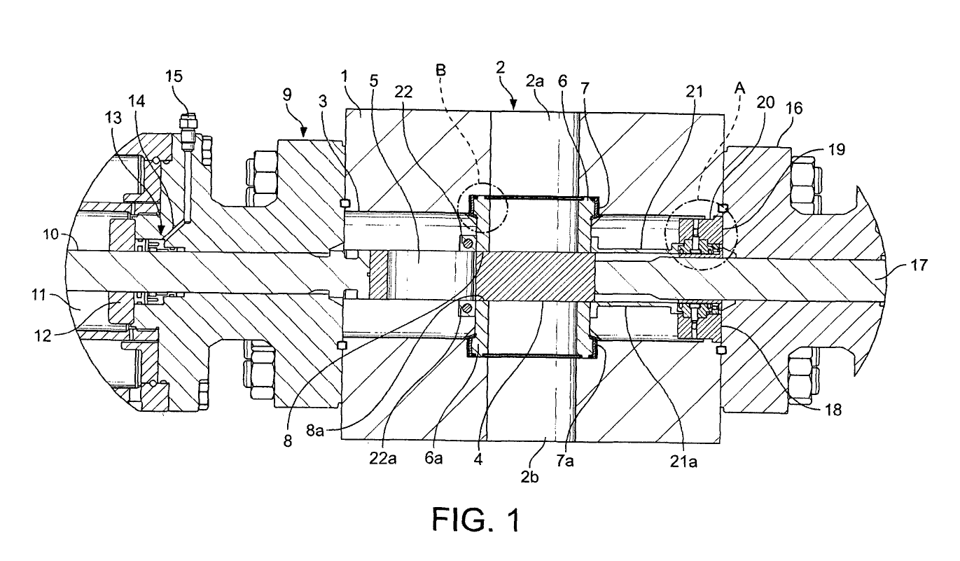

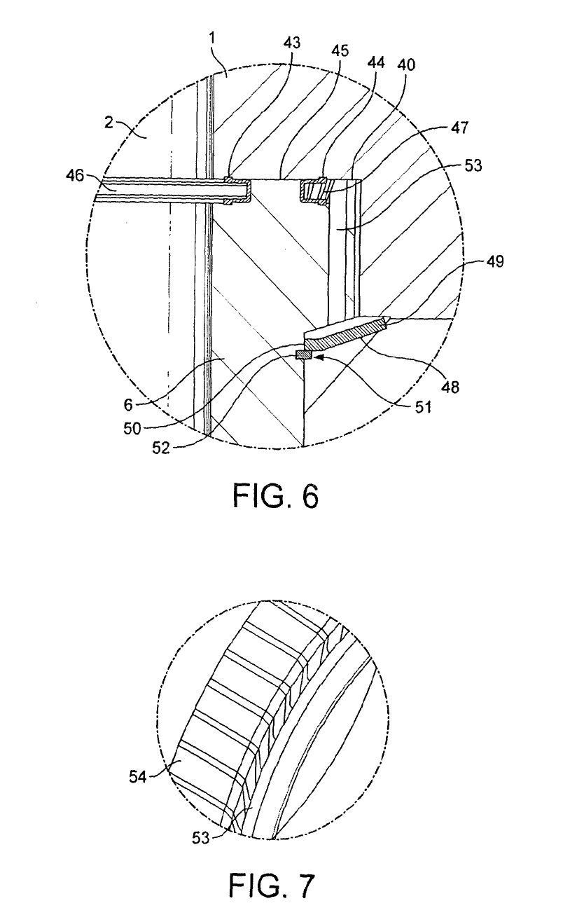

FIG. 1 of the drawings illustrates a truncated section through a valve which incorporates one embodiment of the invention. The section is truncated at each end in order to omit features which are not relevant to the invention. The encircled portion A in FIG. 1 is shown in larger scale in FIG. 3 and the encircled portion B in FIG. 1 is shown In larger scale and reversed in FIG. 6.

The valve comprises a valve body constituted by a metal valve block 1. This block defines aligned portions 2a and 2b of a main passageway 2 for a fluid flow which is to be controlled by the valve.

The main passageway 2 is transverse to a valve cavity 3 which accommodates a valve gate 4. The gate has an aperture 5 which preferably is of the same size and shape as the main passageway 3.

The valve moves between two annular valve seats 6 and 6a. Each seat is located in a respective valve pocket 7, 7a constituted by an annular recess in the block 1 and extending around the respective portion 2a, 2b of the main passageway 2. Each valve seat is annular and defines an aperture which is preferably the same size and shape as the aperture 5 in the valve gate 4. Each valve seat 6, 6a is preferably metallic so that one end 8, 8a respectively makes a metal-to-metal shear seal with the respective side of the valve gate 4.

As the valve gate 4 moves from an open position (not shown) in which the aperture is aligned with the aperture in each valve seat to the closed position (as shown in FIG. 1 it makes a shearing or cutting action in conjunction with each valve seat. Since the relationship between the effective opening of the valve and the position of the valve gate is non linear, a valve as described is normally used to move rapidly between a fully open and a fully closed state, and not to provide any intermediate regulation of flow through the main passageway.

At one side of and secured to the valve block is a ‘bonnet’ 9 which closes one end of the gates' passageway 3 and constitutes a guide for an actuator stem 10 which extends from, in this example, from a piston (not shown) in a hydraulic cylinder 11 to the valve gate, to which the stem 10 is connected. In this example the valve gate 4 is moved from the closed position to the open position hydraulically, but other forms of actuation, such as electromagnetic, may be employed.

The stem 10 extends through a gland 12 and thence through the bonnet 9. The gland closes a chamber 13 which contains an assembly of seals for the stem. From the chamber 13 extends a passageway 14 to a relief valve 15. These features are commonplace and have no significance to the invention.

At one side (the right-hand side as shown in FIG. 1) of the valve block 1 is secured another bonnet 16 which closes the respective end of the gate's passageway 3 and acts as a guide for a stem 17 which extends through the bonnet 16 and abuts the respective end of the valve gate 4. The stem 17 is preferably urged by a strong compression spring (not shown) so as to provide a restoring force tending to move the gate 4 to its closed position. In single ended valves the stem is employed both to pull and to push the gate.

One feature of the exemplary valve is the means by which the end 8, 8a of each valve seat 6, 6a is maintained in position in senses laterally of the seat (i.e. parallel to the plane of movement of the seat 4) and can be adjusted in a lateral direction in a sense along the cavity, i.e. in the direction of movement of the gate.

This feature is also described and is more particularly claimed in our co-pending application entitled ‘Subsea Valves’ filed of even date herewith.

The distal ends 8, 8a of the seats 6 and 6a are a substantial distance from the pockets 7, 7a. They are subject to a considerable vibration and displacing forces in operation, owing to the shearing action of the gate on each of them. Such displacing forces can be both axial (along the direction of the main passageway) and lateral (along the direction of movement of the gate).

The described example includes a seat-retaining clamp which supports at least one and preferably both seats against lateral movement. The clamp also allows for adjustment of each seat in the direction of movement of the gate. The clamp may also allow adjustment in the transverse direction.

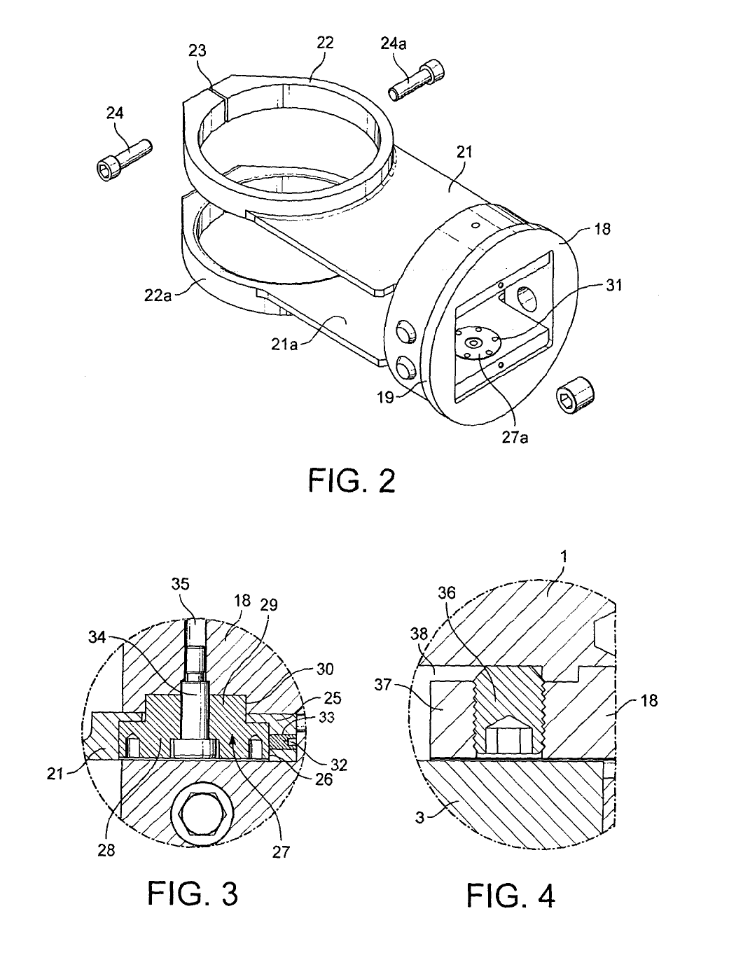

As is shown in both FIGS. 1 and 2, the valve includes a support in the form of a bushing 18 which fits into the valve cavity 3. The bushing has a rim 19 which abuts an annular shoulder 20 in the cavity 3, the shoulder being preferably positioned so that the bushing 18 is disposed flush with the end surface of the block 1 and in abutment with the bonnet 16.

Extending from the support bushing 18 are two plates 21 and 21a. These plates are separated by slightly more than the thickness of the valve gate 4. The plate 21 extends to a clamping ring 22 which can be secured about the valve seat 6. As is shown in FIG. 2, on the opposite side of the ring 22 to the plate 21 the ring has a gap 23 but can be contracted to clamp the seat by means of a fastening screw 24 which extends through the opposing parts of the ring 22 on each side of the gap in the ring.

The use of the plates 21 and 21a is a simple solution. However, other forms of link, possibly including a chain or cable or other linkage, between the clamps and the support 18 may be used to restrain lateral movement of the seat in at least one sense in the direction of movement of the gate.

The clamping ring 22a supported by the plate 21a is similar to the ring 22 and is contractible by means of the screw 24a (FIG. 2).

The plates 21 and 21a are wide and thin so that they are rigid in a direction laterally of the seats (i.e. along and across the passage 3 in the plane of the gate 4) but can flex to allow axial displacement of the valve seats. They are long enough so that the angular movement due to axial movement of the valve seats is insignificant.

Each plate 21, 21a and thereby the respective clamping ring that it carries can be adjusted lateral to the respective valve seat and in the direction of movement of the gate 4. The required adjustment is typically very small, such as 0.25 mm but possibly up to 1 mm.

As is shown in FIG. 3, the plate 21 at its end within the anchor bushing 18 has a flange 25 which defines a circular socket 26. Disposed within this socket is a bush 27 which comprises an eccentric disc 28 and a boss 29 rotatable in a recess 30 in the anchor bushing. The bush 27 can therefore be rotated to produce a small movement of the clamp ring 22 in the direction along the valve cavity 3.

Rotation of the bushing 27 may be effected by engagement of apertures 31 in the base of the disc, as shown in FIG. 2 in respect of the bushing 27a.

The bushing 27 (and similarly the bushing 27a) may be held in a desired angular position by means of a set screw 32 which extends in a threaded bore 33 through the flange to engage the rim of the eccentric disc 28.

The rotatable bushing 27 may be secured to the body of the anchor bushing by means of a retaining screw 34 extending through a central aperture in the bushing 27 to a threaded bore 35 in the anchor bushing.

As is shown in FIG. 4, the anchor bushing 18 may be locked in position within the valve cavity 3 by means of set screw such as the set screw 36 that extends through the cylindrical side wall 37 of the bushing to engage the inside 38 of the valve cavity 3.

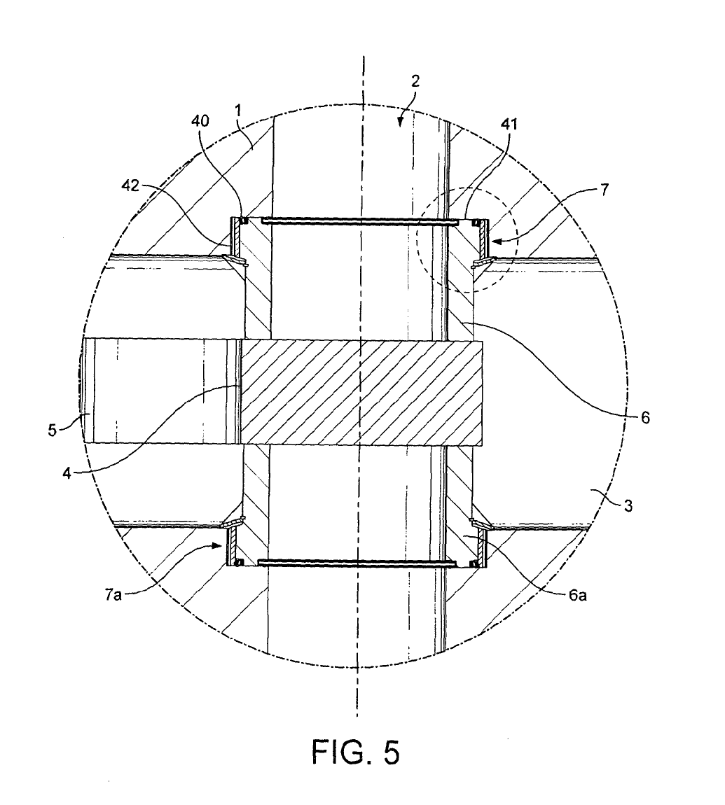

A further feature of the exemplary valve comprises an improvement to the manner in which each valve seat is disposed in its pocket. Only the valve seat 6 and its pocket 7 will be described in detail; the other valve seat 6a and its pocket are similarly disposed. Reference will now be made now to FIGS. 5 to 13.

FIG. 5 is a sectional view of the central part of the valve, including the valve block 1, the main passageway 2, the valve cavity 3, the gate 4 which is movable along the cavity into and out of register with the valve seats 6, 6a, and the pockets 7 and 7a in which the ends of the valve seats remote from the gate are located. Only the valve seat 6 and its pocket 7 will be described in detail; the other valve seat 6a and its pocket are similarly disposed.

The pocket 7 is formed as an annular recess at the intersection of the main passageway 2 and the valve cavity 3. The recess 7 has an axial face 40 against which an inner end face 41 of the seat 6 bears and an annular side face 42. The outer end 8 of the seat 6 bears against the valve gate 4.

The primary sealing between the seat 6 and the gate 4 and between the seat 6 and the pocket 7 is preferably metal-to-metal and in particular between the end face 41 of the seat and the axial face 40 of the pocket and between the end 8 of the seat 7 and the valve gate 4.

The axial seal between the seat 6 and the pocket 7 is augmented by low-pressure seals to provide sealing before the seat shifts under pressure. In this example the low-pressure sealing is provided as shown in FIG. 6 by spring-energised annular U-seals 43 and 44. These seals are disposed in recesses in the end face 41 of the seat 6 and are separated by a land 45 which is to make metal-to-metal contact with the axial face 40 of the pocket 7.

Each of the U-seals 43 and 44 may be a PEEK seal. The inner U-seal 43 is energised by an internal annular spring 46 and the outer U-seal 44 is energised by an internal spring 47.

The seals 43 and 44 are not intended to move the seat 6 against the gate 4. That function is in this example performed by one or more conical springs such as a conical spring 48 of which the outer rim 49 engages the wall of the valve cavity 3 and the inner rim 50 urges the seat axially towards the gate. The inner rim 50 locates against a circular clip 51 disposed in an annular recess 52 on the outside of the seat 6. The conical spring 48 maintains contact between the seat 6 and the gate 4 while allowing some tolerance for thermal expansion. Furthermore it assists the low-pressure sealing and shields the interface between the seat 6 and the pocket 7 from debris.

An important feature of the assembly is a radial buffer between the seat 6 and the pocket 7. It is necessary to hold the seat 6 perpendicular to the valve gate, and to inhibit movement of the seat, especially when the valve operates and the gate moves. It is also desirable to provide a close fit to inhibit the ingress of debris but the close fit must allow for thermal distortion of the seat and the pocket.

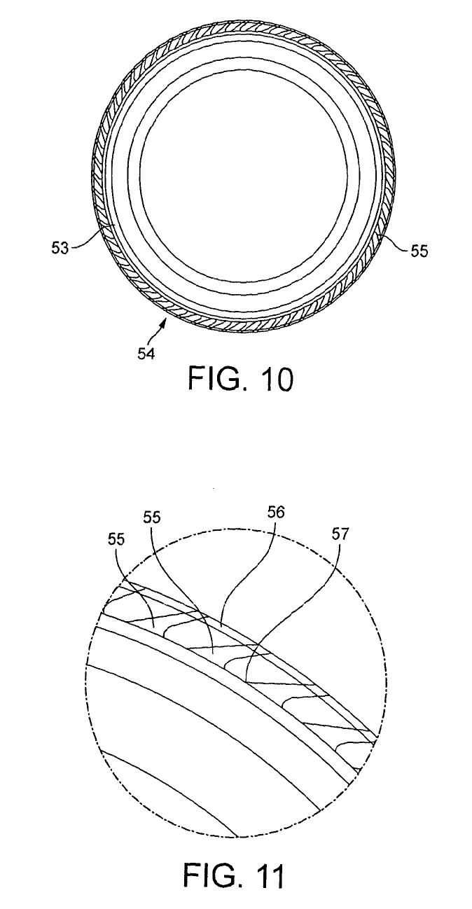

The seat has adjacent the side face of the pocket 7 a rim 53 on which is disposed an annular buffer 54. The buffer comprises (as shown in FIGS. 10 and 11) a multiplicity of flutes 55 each of which extends outwardly and circumferentially with respect to the rim 53. The flutes constitute cantilever springs which are shaped to provide a variable spring rate. The flutes 55 are pliable and facilitate a close radial fit of the seat 6 in the pocket 7. They may be formed integrally with the rim. However, they may be in the form of rectangular section die springs incorporated in a cylindrical elastomeric matrix. The flutes accommodate thermal distortion of the seat and the pocket. In this example they are closely spaced so that the outer end 56 (see FIG. 11) of each flute 55 circumferentially overlaps the base 57 of the next adjacent flute. It is emphasised that the cantilever springs do not necessarily in themselves perform a sealing function. They are there to ensure a close fit of the seat 6 in the pocket 7.

Interspersed between the flutes 55 are moulded elastomeric inserts 58 to provide stability. It is desirable, in order to maximise the stability of the seat, to use a seat which is as short and as wide as feasible and to use a seat pocket which is as deep as feasible. However, the cavity must have a significant dimension in the direction axial to the main passageway 2 and the seat is necessarily subject to a substantial bending movement as the gate 4 moves.

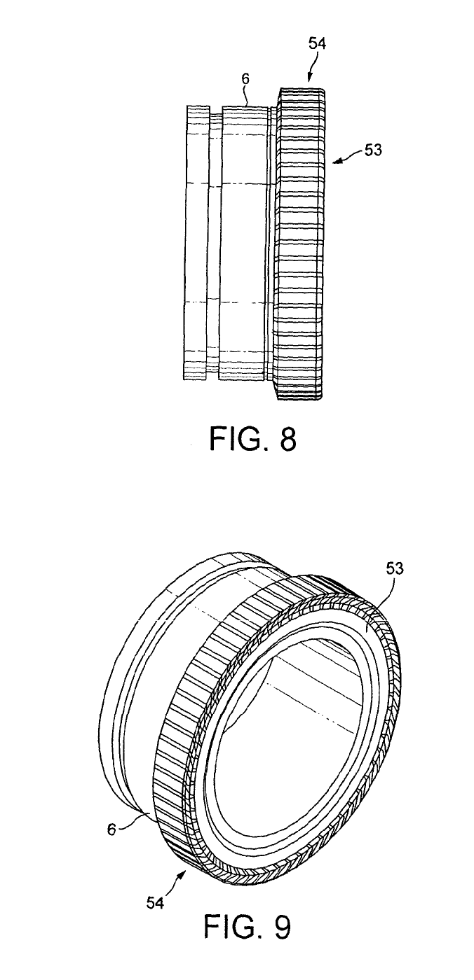

The seat 6 is shown in side view in FIG. 8, in perspective in FIG. 9 and in end view in FIG. 10.

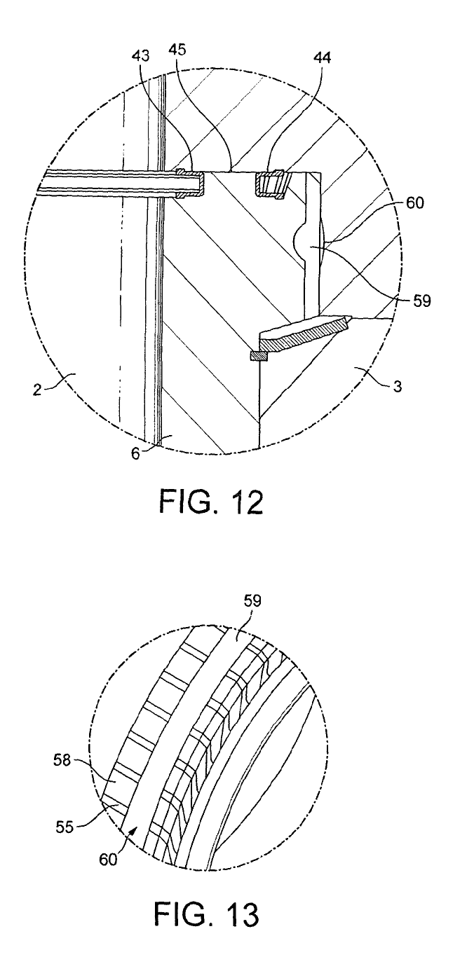

FIGS. 12 and 13 illustrate a modification to the seat arrangement shown in FIGS. 5 to 8.

In this modification the flutes 55 and inserts 58 are formed with a central circumferentially extending groove 59 which has an elastomeric fill 60. This modification may provide a continuous radial seal against the ingress of debris.

1. A subsea valve comprising a valve gate moveable within a valve cavity; a main passageway extending transversely of the cavity; at least one annular valve seat in communication with a respective portion of the main passageway and extending to engage the gate, and an annular pocket accommodating an end of the respective seat remote from the valve gate; in which the seat has at the said end an annular buffer in radial engagement with the pocket and comprising a multiplicity of springs each extending radially and circumferentially of the seat.

2. A subsea valve according to claim 1 in which the springs are in the form of flutes to provide a variable spring rate.

3. A subsea valve according to claim 2 in which the tip of each flute overlaps the base of an adjacent flute in the circumferential direction.

4. A subsea valve according to claim 2 in which the buffer includes a circumferential groove in the flutes and elastomeric filler in the groove to form a radial seal with the pocket.

5. A subsea valve according to claim 1 in which elastomeric material is interspersed between the springs.

6. A subsea valve according to claim 1 and further comprising at least one conical spring disposed between the cavity and the seat and to urge the seat towards the valve gate.

7. A subsea valve according to claim 1 and further comprising at least one axial seal between the sea and the pocket.

8. A subsea valve according to claim 1 wherein there are two aligned valve seats each of which is in communication with a respective portion of the passageway and extends from a respective pocket to a respective face of the gate.

9. A valve seat for use in a subsea gate valve and comprising an annular member having a first end for engagement with a valve gate and a second end for location in an annular pocket; in which the seat has at the said second end a rim carrying a multiplicity of springs each extending radially and circumferentially of the rim.

10. A subsea valve seat according to claim 9 in which the springs are formed as flutes to provide a variable spring rate.

11. A subsea valve seat according to claim 10 in which the rim includes a circumferential groove in the flutes and elastomeric filler in the groove to form a radial seal with the pocket.

12. A subsea valve seat according to claim 9 in which elastomeric material is interspersed between the springs.
